(19) United States
(12) Patent Application Publication
(10) Pub. No.: US 2020/0302662 A1
(43) Pub. Date: Sep. 24, 2020

(54) System and Methods for Generating High Definition Maps Using Machine-Learned Models to Analyze Topology Data Gathered From Sensors

(71) Applicant: UATC, LLC, San Francisco, CA (US)

(72) Inventors: Namdar Homayounfar, Toronto (CA); Justin Liang, Toronto (CA); Wei-Chiu Ma, Toronto (CA); Raquel Urtasun, Toronto (CA)

(21) Appl. No.: 16/825,518

(22) Filed: Mar. 20, 2020

Related U.S. Application Data
(60) Provisional application No. 62/942,494, filed on Dec. 2, 2019.
(60) Provisional application No. 62/822,841, filed on Mar. 23, 2019.

(51) Int. Cl. G06T 11/20; G06K 9/00

(52) U.S. Cl. CPC G06T 11/206; G01S 13/931; G06K 9/00798

(57) ABSTRACT

The present disclosure is directed to generating high quality map data using obtained sensor data. In particular a computing system comprising one or more computing devices can obtain sensor data associated with a portion of a travel way. The computing system can identify, using a machine-learned model, feature data associated with one or more lane boundaries in the portion of the travel way based on the obtained sensor data. The computing system can generate a graph representing lane boundaries associated with the portion of the travel way by identifying a respective node location for the respective lane boundary based in part on identified feature data associated with lane boundary information, determining, for the respective node location, an estimated direction value and an estimated lane state, and generating, based on the respective node location, the estimated direction value, and the estimated lane state, a predicted next node location.

### RELATED APPLICATION

This application claims priority to and the benefit of U.S. Provisional Patent Application No. 62/822,841, filed Mar. 23, 2019 and U.S. Provisional Patent Application No. 62/942,494, filed Dec. 2, 2019, which are hereby incorporated by reference in their entirety.

### FIELD

The present disclosure relates generally to computer-based mapping. More particularly, the present disclosure relates to using sensor data to generate high quality maps for use with autonomous vehicles.

### BACKGROUND

An autonomous vehicle is a vehicle that is capable of sensing its environment and navigating without human input. In particular, an autonomous vehicle can observe its surrounding environment using a variety of sensors and can attempt to comprehend the environment by performing various processing techniques on data collected by the sensors. Given knowledge of its surrounding environment, the autonomous vehicle can identify an appropriate motion path for navigating through such surrounding environment.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method. The method can include obtaining, by a computing system comprising one or more computing devices, sensor data associated with a portion of a travel way. The method can include identifying, by the computing system and using a machine-learned model, feature data associated with one or more lane boundaries in the portion of the travel way based on the obtained sensor data. The method can include generating, by the computing system and the machine-learned model, a graph representing the one or more lane boundaries associated with the portion of the travel way. The method can include identifying, by the computing system, a respective node location for the respective lane boundary based at least in part on identified feature data associated with lane boundary information. The method can include determining, by the computing system, for the respective node location, an estimated direction value and an estimated lane state. The method can include generating, by the computing system and based at least in part on the respective node location, the estimated direction value, and the estimated lane state, a predicted next node location.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example system overview according to example embodiments of

the present disclosure;

FIG. 2 depicts an example autonomous vehicle in a multi-lane road environment in accordance with the present disclosure;

FIG. 3 depicts an example system overview according to example embodiments of the present disclosure;

FIG. 4 depicts an example system overview according to example embodiments of the present disclosure;

FIG. 5 depicts an of a directed acyclic graph according to example embodiments of the present disclosure;

FIG. 6 depicts an example flow diagram according to example embodiments of the present disclosure;

FIG. 7 depicts an example flow diagram for generating a graph representation of a road according to example embodiments of the present disclosure;

FIG. 8 depicts an example system with units for performing operations and functions according to example aspects of the present disclosure; and

FIG. 9 depicts example system components according to example aspects of the present disclosure.

### DETAILED DESCRIPTION

Generally, the present disclosure is directed to generating a representation of a road by discovering lane topology. A mapping service can access sensor data from a vehicle (e.g., an autonomous vehicle) that has traversed a section of a travel way. The mapping service, using a machine-learned model, can extract feature data from the sensor data (e.g., LIDAR data and/or camera data). The feature data can include a representation of important features in the sensor data including lane boundaries and changes in topology. The mapping service can use the generated feature data as input to a machine-learned model, to generate a graph representing one or more lanes (e.g., based on lane boundaries) in the section of the travel way. To do so, the mapping service determines, using the feature data, an initial node (or vertex) of the graph for a given lane boundary. The mapping service can determine the position of the initial node. The mapping service can then generate, for each lane boundary, an estimated direction and an estimated state for the initial node based, at least in part, on the feature data. Using the position, the estimated direction, and the estimated state for the initial node, the mapping service can determine the location and orientation of an area of interest.

The mapping service can predict, based at least in part on the feature data, the position of the next node in the graph within the area of interest. In addition, the estimated state can be assigned one of several different values, including a normal state (e.g., the lane boundary continues unchanged), a fork state (a new lane boundary is being created by forking the current lane boundary into two lane boundaries), and a termination state (e.g., the current lane boundary is ending). If the estimated lane state is a fork state, the mapping system can create another lane boundary in the graph (e.g., representing the new lane). If the estimated lane state for a node in the graph of a respective lane boundary is a termination state, the mapping system can cease generating new nodes for the respective lane boundary (e.g., the lane has merged into another lane and ended). The mapping service can continue iteratively predicting new node locations using the above process until it reaches the end of the section of the travel way represented in the sensor data.

The systems and methods of the present disclosure provide improved techniques for generating high-definition map data based on sensor data captured by a vehicle passing through the area to be mapped. Such high-definition maps can be an important component in enabling navigation by autonomous vehicles. More particularly, an autonomous vehicle can combine map data with information received from one or more sensors (a camera, a LIDAR sensor, or a RADAR sensor) to successfully generate motion plans from a first location to a second location.

An autonomous vehicle can include a vehicle computing system. The vehicle computing system can be responsible for creating the control signals needed to effectively control an autonomous vehicle. The vehicle computing system can include an autonomy computing system. The autonomy computing system can include one or more systems that enable the autonomous vehicle to plan a route, receive sensor data about the environment, predict the motion of other vehicles, generate a motion plan based on the sensor data and predicted motion of other vehicles, and, based on the motion plan, transmit control signals to a vehicle control system and thereby enable the autonomous vehicle to move to its target destination.

For example, an autonomy computing system can access sensor data from one or more sensors to identify objects in the autonomous vehicle's environment. Similarly, the autonomous vehicle can use a positioning system or a communication system to determine its current location. Based on this location information, the autonomy computing system can access high definition map data to determine the autonomous vehicle's current position relative to other objects in the world, such as lane boundaries, buildings, and so on. As such, map data can be extremely important in enabling the autonomous computing system to effectively control the autonomous vehicle.

In some example embodiments, a perception system can access one or more sensors to identify one or more objects in the local environment of the autonomous vehicle. The sensors can include but are not limited to camera sensors, LIDAR sensors, and RADAR sensors. Using this sensor data, the perception system can generate perception data that describes one or more objects in the vicinity of the autonomous vehicle. The generated perception data can be sent to a prediction system. The prediction system can use the perception data to generate predictions for the movement of one or more objects. In some implementations, the perception and prediction functions can be implemented within the same system/component. This prediction data can be sent to a motion planning system. The motion planning system can use received prediction data and map data to generate a motion plan.

In some examples, a motion plan can describe a specific route for the autonomous vehicle to take from a current location to a destination location. In some examples, the motion plan can include one or more route segments. Each route segment can describe a section of a planned path for the autonomous vehicle. In some examples, the motion planning system can send one or more motion plans to the vehicle control system. The vehicle control system can use the received motion plans to generate specific control signals for the autonomous vehicle. The specific control signals can cause the autonomous vehicle to move in accordance with the motion plan.

A vehicle (e.g., an autonomous vehicle or another vehicle type that includes sensor equipment) can travel through a portion of a travel way (e.g., a road or other thoroughfare) and capture sensor data of the environment around the vehicle. In some examples, the vehicle can employ one or more of: a camera, a LIDAR system, or a RADAR system to capture data of the environment surrounding the vehicle. The vehicle only needs to travel through the portion of the travel way that is of interest once to capture sensor data for the environment surrounding the vehicle.

The surrounding environment of the vehicle can include, for example, a highway environment, an urban environment, a residential environment, a rural environment, and/or other types of environments. The surrounding environment can include one or more objects (e.g., another vehicle, an obstacle such as a building, a pedestrian, and so on). The surrounding environment can include one or more lane boundaries. A lane boundary can include, for example, lane markings and/or other indicia associated with a travel lane and/or travel way.

Once a vehicle has traveled through a particular portion of a travel way, the captured sensor data can be used as input to a road topology mapping system. In some examples, the sensor data can include LIDAR data associated with the surrounding environment of the vehicle. The LIDAR data can be captured via a roof-mounted LIDAR system of the vehicle. The LIDAR data can be indicative of a LIDAR point cloud associated with the surrounding environment of the vehicle (e.g., created by LIDAR sweep(s) of the vehicle's LIDAR system). The computing system can project the LIDAR point cloud into a two-dimensional overhead view image (e.g., a bird's eye view image with a resolution of 960×960 at a 5 cm per pixel resolution). The rasterized overhead view image can depict at least a portion of the surrounding environment of the vehicle (e.g., a 48 m by 48 m area with the vehicle at the center bottom of the image). The LIDAR data can provide a sparse representation of at least a portion of the surrounding environment. In some implementations, the sensor data can be indicative of one or more sensor modalities (e.g., encoded in one or more channels). This can include, for example, intensity (e.g., LIDAR intensity) and/or other sensor modalities. In some implementations, the sensor data can also include other types of sensor data (e.g., motion sensor data, camera sensor data, RADAR sensor data, SONAR sensor data, and so on).

The sensor data can be used as input to the road topology mapping system. The road topology mapping system can include one or more components that enable the road topology mapping system to generate high-definition map data based on the sensor data, the components of the road topology mapping system including a feature extraction system, a state determination system, and a map generator. The feature extraction system can include a machine-learned model. The machine-learned model can, using a LIDAR point cloud and camera data as input, identify one or more features in the environment including, but not limited to, lane boundaries (e.g., lines painted on the surface of a travel way including solid lines and dashed lines), topography of the travel way (e.g., changes in elevation and turns), and obstacles (e.g., permanent features of the landscape and buildings). The feature extraction system can then output a set of features for the portion of the travel way in which the sensor data was captured.

A state determination system can access the set of features produced by the feature extraction system. Based on that list of features, the state determination system can identify an initial vertex point for the area covered by the sensor data. For example, the state determination system can determine a first edge of the area represented by the sensor data and identify a position at which at least one lane boundary intersects the edge of the data. Once the initial node position is determined, the state determination system can determine one or more other characteristics of the node.

Using a machine-learned model and the feature data set, the state determination system can determine a direction associated with the initial node (e.g., the direction in which the associated lane boundary is likely to continue in) and a state associated with the node. A state value can be one of: a fork state, a termination state, and a normal state (which can also be referred to as an unchanged state). A fork state can be determined when the current lane boundary is diverging into two lane boundaries. For example, an exit on a highway includes a new lane being introduced to allow vehicles to exit the highway. The lane boundary of a lane at the edge of the highway will diverge from the existing path to allow vehicles to exit. When a fork state is determined, the road topology mapping system (using the map generator) can create a new lane boundary in a graph that represents the current travel way.

A termination state can represent that the current lane boundary is ending. This can occur when two lanes merge together and one of them no longer continues separately. Thus, when the most recent node for a specific lane boundary is determined to be in a termination state, the road topology mapping system can cease generating new nodes for that lane boundary. An unchanging state can represent that the lane boundary continues on to the next node without forking or termination. In some examples, the state determination system can determine a state for a node based on features in the feature set. Such features may include representations of the location and direction of lane boundary lines. For example, an intersection of the current lane boundary with another lane boundary may indicate that the lane boundary is in a termination state and an unexpected change of direction for a given lane boundary that is not found in other lane boundaries may indicate a fork in the lane boundary is beginning.

A map generator can, using the position, direction, and state information generated by the state determination system, generate a directed graph of nodes that represent the position and path of one or more lane boundaries. The map generator can represent each lane boundary as a series of nodes, each node having an associated location, direction, and state. The directed graph can be generated iteratively, such that for each new node, the map generator or state determination system can identify an area of interest based on the determined state and direction for the new node. Using this identified area of interest and the feature set output by the feature extraction system, the map generator can identify a correct position for the next node in the directed graph. This process can continue until the road topology mapping system reaches the end of the current sensor data set.

It should be noted that while a directed acyclic graph the representation that is primarily herein, other representations of lane boundaries can be produced by a machine-learned model. For example, the lane boundaries can be represented as a plurality of structured directed acyclic graphs that correspond to each lane boundary. Additionally, or alternatively, the graph can be represented based on a probabilistic graph model for graphically expressing the conditional dependence of variables.

The road topology mapping system can output road boundary data. The road boundary data can include a representation of a plurality of lane boundaries in an acyclic directed graph. This boundary data can be used, with other map data, to provide a high-definition map for use by autonomous vehicles while navigating the section of a travel way represented by the road boundary data.

More specifically, the road topology mapping system can include a plurality of components, each component associated with performing a particular part of the process of generating high-definition maps. The sensor data can include data representing a top-down view of a portion of a travel way (e.g., a road) based on point cloud data collected by a LIDAR system mounted on top of a vehicle and camera data.

A machine-learned model can accept the sensor data as input. For example, the machine-learned model can be a convolutional neural network. Because the changes of topology can be very gradual in a given area in the mapped data, it can be difficult for the machine-learned model to correctly identify state changes based on data collected for a relatively limited field of view around a vehicle. To enable better prediction of a current state, the road topology mapping system can employ a global feature network to generate context for each specific node in the lane boundary map. The road topology mapping system can generate one or more bird's eye view images (e.g., images of dimension 8000 pixels in width by 1200 in height corresponding to 400 m by 60 m in the direction of travel of the mapping vehicle). The global feature network can use an encoder-decoder architecture built upon a feature pyramid network that encodes the context of the lane boundaries and the scene. This represents a bottom-up, top-down structure that can enable the global feature network to process and aggregate multi-scale features and skip links that help preserve spatial information at each resolution. These multi-scale features can enable later components of the mapping system to contextualize each node such that the state of a given node can more accurately be determined.

The road topology mapping system can also use a distance transform network to generate a distance transform representation of the sensor data. A distance transform representation of a portion of a travel way can encode, at each point in the image, the relative distance to the closest lane boundary. A distance transform representation of a particular portion of a travel way can be used as an additional input to other portions of the road topology mapping system. In addition, the distance transform representation can be analyzed (e.g., binarizing and skeletonizing) to identify one or more locations to serve as the initial node(s) (or vertex(es)) of the graph.

It should be noted that, although the present system generally relies on a multi-scale feature representation and a distance transform representation of the particular portion of the travel way, other representations can be generated based on the sensor data. For example, the sensor data can be analyzed (e.g., by a trained neural network) to generate a truncated inverse distance transform of the location of the travel way boundaries (e.g., a lane boundary detection map), an endpoint map, and a vector field of normalized normal values to the road boundaries (e.g., a direction map which can be represented as a flow field).

Once a multi-scale feature data set and a distance transform representation have been generated, the road topology mapping system can concatenate them to produce a combined representation of the portion of the travel way included in the sensor data.

In some examples, the road topology mapping system can use the combined representation as input to one or more further machine-learned models (e.g., neural networks). For example, the road topology mapping system can identify an initial node (or vertex) based on the distance transform representation. For each node, the road topology mapping system can generate a header. In some examples, the header can include one or more sub-headers, each sub-header including information about the node. For example, a header for a current node can include a direction header, a state header, and a position header. The position header can describe the position of the current node. This position can be an absolute position (e.g., using GPS coordinates) or a relative position within a given area or image. The direction header can include data describing an estimated direction for the lane boundary that the current node is part of. Thus, the direction header can be used to determine where the next node may be. The state header can include information about the state of the current node. As noted above, potential states can include a normal state, a fork state, and a termination state.

Using a machine-trained model, the row topology mapping system can determine an estimated direction for the current node (e.g., the initial node or some subsequent node). In some examples, the estimated direction is based on one or more topological features, one or more features describing the position and direction of the lane boundaries, and the estimated direction for the parent node of the current node. In the example of the initial node, no direction information will be available for the parent node. The estimated direction can be stored in the direction header.

The road topology mapping system can generate a region of interest for the next node in the directed graph based on the estimated direction associated with the current node. Thus, the road topology mapping system can identify the location of the next node for the current lane boundary within the area of interest based on one or more lane boundary features and the distance transform representation. For example, if the estimated direction is directly eastward, the road topology mapping system can generate an area of interest that is directly eastward of the current node. The size (e.g., the length and width) of the area of interest can be determined based on the number of nodes needed for the high definition mapping data.

The road topology mapping system can use the generated region of interest, along with the feature data as input to a machine-trained model to determine a state for the current node. This model considers the feature data for the current region of interest (and any other relevant features) to determine whether the current lane boundary is diverging from a given path (e.g., forking to create a new lane boundary) or is intersecting with another lane boundary (e.g., merging). The model can generate a confidence value for each of the three possible states and select the state with the highest generated confidence value.

The road topology mapping system can use another machine-learned model (or a portion of an existing machine-learned model) to identify the next node for the current lane boundary within the area of interest. For example, a convolutional neural network can predict a probability distribution over all possible positions within the region of interest along the lane boundary generated by the direction header. The region of interest can be bilinearly interpolated from the combined representation and an encoding of the state of the current node. After the interpolation, the road topology mapping system can up-sample the region of interest to the original image dimension and passes it to a convolutional recurrent neural network (RNN). The output of the RNN can be fed to a lightweight encoder-decoder network that outputs a soft-max probability map of the position of the next node that is mapped to a global coordinate frame of the image.

For example, the mapping system can identify a particular point along a lane boundary (which is identified based on the feature data) and established that point as the location of the next node (or vertex) in the directed graph. Each new node can be added to the directed graph (along with any pertinent header information). Depending on the state, a graph describing a current lane boundary can end (if the current node is determined to be in a termination state). Alternatively, if the current node is determined to be in a fork state, the road topology mapping system can generate a new lane boundary to be represented within the graph.

Once the road mapping topology system identifies the location of the next node in the graph for a given road boundary, the process of determining, using machine-learned models, the estimated direction and estimated state for that node is repeated. The entire process can be repeated to identify additional nodes until the end of the data is reached (e.g., the end of the area of travel way represented by the sensor data.)

Thus, given input sensor data D, the output of the system will be a most likely directed graph (G) from the plurality of all possible directed graphs. The graph will include a series of nodes (v), each node encoding geometric and topological properties of a local region of a lane boundary. For example, each node can be defined as vi=(xi, θi, si), wherein xi represents the position of a vertex represented by the node, θi represents the turning angle of the previous vertex position, and si is a variable that represents the state of the lane boundary at this node. The process of generating a graph (G) of a plurality of nodes (v) can be represented as:

$${V}^{*} = arg {max}_{v ∈ G} p ( V \vert D )$$

Thus, the characteristics of each node can be calculated based on Bayes-ball algorithm, the joint probability distribution p(V|D) of each graph can be factorized into:

$$p ( v ) = {\prod }_{{v}_{i} ∈ V} p ( {v}_{i} \vert {v}_{ip ( i )} , D )$$

Each conditional probability can further be decomposed into the specific geometric and topological components as follows:

p(vᵢ|vᵢₚ₍ᵢ₎,D)=p(θᵢ|θₚ₍ᵢ₎,sₚ₍ᵢ₎,xₚ₍ᵢ₎,D)×p(xᵢ|θᵢ,sₚ₍ᵢ₎,xₚ₍ᵢ₎,D)×p(sᵢ|θᵢ,sₚ₍ᵢ₎,xₚ₍ᵢ₎,D)

An example algorithm for generating a directed acyclic graph is shown below. This general pseudo code represents a particular implementation of the method described herein.

```
Input: Sensor data (Aggregated point clouds) and initial vertices {vᵢₙᵢₜ = (θᵢₙᵢₜ, xᵢₙᵢₜ,
sᵢₙᵢₜ)}
Output: Directed Acyclic Graph of Highway Topology
Initialize queue Q with vertices {vᵢₙᵢₜ};
while Q not empty do
  vᵢ ← Q.pop( );
  while _{Sp(i)} not Terminate do
    θᵢ ← argmax p(θᵢ | θₚ₍ᵢ₎, _{SP(i)}, _{XP(i)});
    xᵢ ← argmax p(xᵢ | θ_{i, SP(i)}, _{XP(i)});
    sᵢ ← argmax p(sᵢ | θᵢ, _{SP(i)}, _{XP(i)});
    if sᵢ = Fork then
      Q.insert(vᵢ);
    end
    i ← C(i);
  end
end
```

As seen above, the method describes a system that takes input in the form of sensor data (e.g., aggregated point clouds) and initial vertices. Each initial vertex represents a specific lane boundary. The initial vertices are stored as a list of points in a queue (Q), each with a location (xᵢₙᵢₜ), a direction (θᵢₙᵢₜ), and a state (sᵢₙᵢₜ). The system can then access the first initial vertex(vᵢₙᵢₜ) from the queue. The method then, as long as the state of the current node (in this case the initial node), is not “terminate” the system will calculate a most likely direction (θᵢ) for the new current node based on the direction of the previous node θₚ₍ᵢ₎, the state of the previous node (sₚ₍ᵢ₎), and the location of the previous node (xₚ₍ᵢ₎).

The system can then calculate a most likely position (xᵢ) for the current node based on the estimated direction (θᵢ) of the previous node calculated in the last step, the state of the previous node (sₚ₍ᵢ₎), and the location of the previous node (xₚ₍ᵢ₎). The system can calculate a most likely state (si) for the current node based on the estimated direction (θᵢ) of the current node calculated in the last step, the state of the previous node (sₚ₍ᵢ₎), and the location of the previous node (xₚ₍ᵢ₎). If the state of the current node is a fork state, the system inserts a new initial vertex for a new lane boundary into the queue (Q).

The system can identify a child node of the current node and assign it as the new current node and then repeat the above process until all the lane boundaries have been mapped to completion.

The road topology mapping system can output an acyclic directed graph representing a plurality of lane boundaries (wherein the lane boundaries define the lanes of a highway or road.) The graph is acyclic because there are no paths within the graph that can return to a node once it has been traversed. The graph is directed because the paths from one node to another only run in a single direction. The graph can be composed of a plurality of nodes or vertices connected by a plurality of edges. In some examples, the nodes can have states that represent the beginning of a lane boundary (e.g., a fork state) or the end of a lane boundary (e.g., a termination state). These acyclic directed graphs can be used to generate high-definition maps for use by autonomous vehicles.

In some examples, the road topology mapping system generates a graph for a travel way with multiple different lane boundaries. To do so, the road topology mapping system identifies a plurality of initial vertices or nodes, one for each lane boundary. The initial vertex can represent the position at which each lane boundary intersects an edge of the sensor data (e.g., the edge of an image or a point cloud). For each initial vertex or node, the road topology mapping system can process the sensor data to determine a series of nodes for that lane boundary. The road topology mapping system can continue to generate nodes for that lane boundary until the lane boundary is determined to reach a termination point for that lane boundary. The termination point for a particular lane boundary can be the point at which it merges with another lane boundary or the point at which it reaches another edge of the sensor data.

Once all the nodes for a particular lane boundary are determined, the road topology mapping system can continue that process with another initial node for the next lane boundary. This process can be repeated until all lane boundaries have been mapped to completion.

The machine-learned model can include a plurality of steps performed by one or more components of the machine-learned model. However, all components can be trained together using an end-to-end model learning system. In some examples, the end-to-end model training can be enabled because the components are all differentiable. Specifically, the system can train a model using a symmetric Chamfer distance to determine how closely a specific graph (or directed acyclic graph) Q matches a predicted graph (or directed acyclic graph) using the following formula:

$$L ( P , Q ) = {\sum }_{i} {min}_{q ∈ Q} {‖ {p}_{i} - q ‖}_{2} + {\sum }_{j} {min}_{p ∈ Q} {‖ p - {q}_{j} ‖}_{2}$$

Note that p and q are the densely sampled coordinates on directed acyclic graphs P and Q respectively.

The systems and methods described herein provide a number of technical effects and benefits. More particularly, the systems and methods of the present disclosure provide improved techniques for generating high definition maps for autonomous vehicles. For instance, the road topology mapping system (and its associated processes) allow a map to be generated based on sensor data gathered in a single pass of a vehicle, rather than multiple passes, greatly speeding up the process and reducing cost. In addition, the road topology mapping system determines a state for each node as it builds a graph. Using this state information, it is able to more accurately map the lane boundaries it detects, removing the need for close human supervision of the process and efficiently reducing both the time and the expense required. Specifically, predicting a state of a lane boundary for each node allows the road topology mapping system to correctly interpret complex topology (e.g., lane forks and lane mergers). The road topology mapping system is thus able to avoid the problems existing mapping systems have when trying to correctly map complex topology problems. The efficiency gained when this process is used to generate maps leads to the efficient production of maps while minimizing errors. Error-free maps allow autonomous vehicles to navigate travel ways more safely. As such, the disclosed mapping techniques lead to an increase in safety as well as reductions in the time and cost of generating maps that are sufficiently precise for autonomous vehicles to use.

Various means can be configured to perform the methods and processes described herein. For example, a computing system can include data obtaining unit(s), feature identification unit(s), graph generation unit(s), lane boundary unit(s), state determination unit(s), node estimation unit(s) and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain sensor data associated with a portion of a travel way. The means can be configured to identify, using a machine-learned model, feature data associated with one or more lane boundaries in the portion of the travel way based on the obtained sensor data. The means can be configured to generate, using the machine-learned model, a graph representing the one or more lane boundaries associated with the portion of the travel way.

To generate the graph for a respective lane boundary, the means can be configured to identify a respective node location for the respective lane boundary based at least in part on identified feature data associated with lane boundary information. The means can be configured to determine, for the respective node location, an estimated direction value and an estimated lane state. The means can be configured to generate, based at least in part on the respective node location, the estimated direction value, and the estimated lane state, a predicted next node location.

With reference to the figures, example embodiments of the present disclosure will be discussed in further detail.

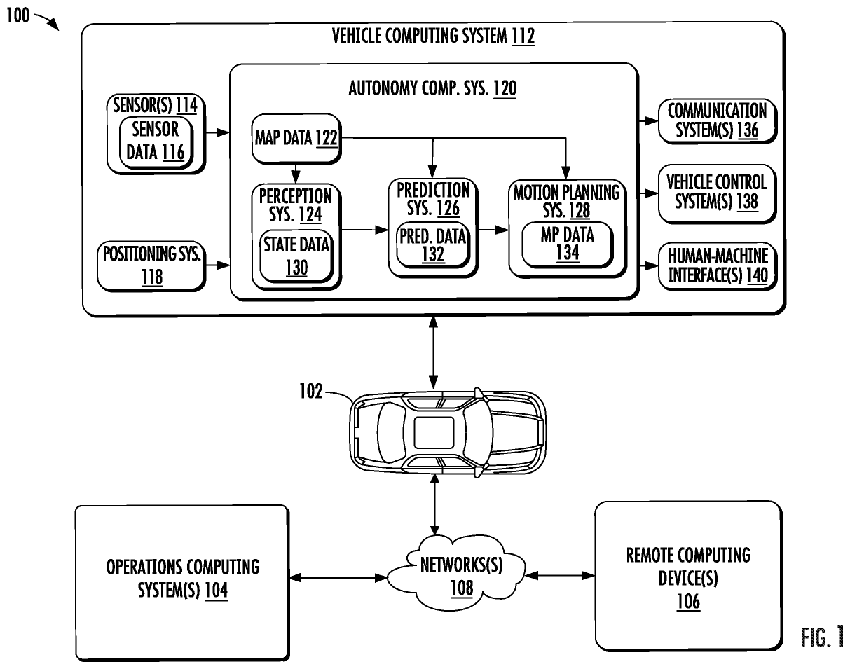

FIG. 1 depicts a block diagram of an example system 100 for controlling the navigation of a vehicle according to example embodiments of the present disclosure. As illustrated, FIG. 1 shows a system 100 that can include a vehicle 102; an operations computing system 104; one or more remote computing devices 106; a communication network 108; a vehicle computing system 112; one or more autonomy system sensors 114; autonomy system sensor data 116; a positioning system 118; an autonomy computing system 120; map data 122; a perception system 124; a prediction system 126; a motion planning system 128; state data 130; prediction data 132; motion plan data 134; a communication system 136; a vehicle control system 138; and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with operation of one or more vehicles (e.g., a fleet of vehicles), with the provision of vehicle services, and/or other operations as discussed herein.

For example, the operations computing system 104 can be configured to monitor and communicate with the vehicle 102 and/or its users to coordinate a vehicle service provided by vehicle 102. To do so, the operations computing system 104 can manage a database that includes data including vehicle status data associated with the status of vehicles including vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radiofrequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the vehicle 102 including exchanging (e.g., sending and/or receiving) data or signals with the vehicle 102, monitoring the state of the vehicle 102, and/or controlling the vehicle 102. The one or more remote computing devices 106 can communicate (e.g., exchange data and/or signals) with one or more devices including the operations computing system 104 and the vehicle 102 via the communications network 108.

The one or more remote computing devices 106 can include one or more computing devices (e.g., a desktop computing device, a laptop computing device, a smartphone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the vehicle 102 including a location (e.g., latitude and longitude), a velocity, acceleration, a trajectory, and/or a path of the vehicle 102 based in part on signals or data exchanged with the vehicle 102. In some implementations, the operations computing system 104 can include the one or more remote computing devices 106.

The vehicle 102 can be a ground-based vehicle (e.g., an automobile, bike, scooter, other light electric vehicles, etc.), an aircraft, and/or another type of vehicle. The vehicle 102 can be an autonomous vehicle that can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the vehicle 102. Additionally, the vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the vehicle 102 in one or more memory devices associated with the operations computing system 104 (e.g., remote from the vehicle). Furthermore, the vehicle 102 can provide data indicative of the state of the one or more objects (e.g., physical dimensions and/or appearance of the one or more objects) within a predefined distance of the vehicle 102 to the operations computing system 104, which can store an indication, record, and/or other data indicative of the state of the one or more objects within a predefined distance of the vehicle 102 in one or more memory devices associated with the operations computing system 104 (e.g., remote from the vehicle).

The vehicle 102 can include and/or be associated with the vehicle computing system 112. The vehicle computing system 112 can include one or more computing devices located onboard the vehicle 102. For example, the one or more computing devices of the vehicle computing system 112 can be located on and/or within the vehicle 102. The one or more computing devices of the vehicle computing system 112 can include various components for performing various operations and functions. For instance, the one or more computing devices of the vehicle computing system 112 can include one or more processors and one or more tangible, non-transitory, computer-readable media (e.g., memory devices). The one or more tangible, non-transitory, computer-readable media can store instructions that when executed by the one or more processors cause the vehicle 102 (e.g., its computing system, one or more processors, and other devices in the vehicle 102) to perform operations and functions, including those described herein.

As depicted in FIG. 1, the vehicle computing system 112 can include the one or more autonomy system sensors 114; the positioning system 118; the autonomy computing system 120; the communication system 136; the vehicle control system 138; and the human-machine interface 140. One or more of these systems can be configured to communicate with one another via a communication channel. The communication channel can include one or more data buses (e.g., controller area network (CAN)), onboard diagnostics connector (e.g., OBD-II), and/or a combination of wired and/or wireless communication links. The onboard systems can exchange (e.g., send and/or receive) data, messages, and/or signals amongst one another via the communication channel.

The one or more autonomy system sensors 114 can be configured to generate and/or store data including the autonomy system sensor data 116 associated with one or more objects that are proximate to the vehicle 102 (e.g., within a range or a field of view of one or more of the one or more sensors 114). The one or more autonomy system sensors 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy system sensor data 116 can include image data, radar data, LIDAR data, and/or other data acquired by the one or more autonomy system sensors 114. The one or more objects can include, for example, pedestrians, vehicles, bicycles, and/or other objects. The one or more sensors can be located on various parts of the vehicle 102 including a front side, rear side, left side, right side, top, or bottom of the vehicle 102. The autonomy system sensor data 116 can be indicative of locations associated with the one or more objects within the surrounding environment of the vehicle 102 at one or more times. For example, autonomy system sensor data 116 can be indicative of one or more LIDAR point clouds associated with the one or more objects within the surrounding environment. The one or more autonomy system sensors 114 can provide the autonomy system sensor data 116 to the autonomy computing system 120.

In addition to the autonomy system sensor data 116, the autonomy computing system 120 can retrieve or otherwise obtain data including the map data 122. The map data 122 can provide detailed information about the surrounding environment of the vehicle 102. For example, the map data 122 can provide information regarding: the identity and location of different roadways, road segments, buildings, or other items or objects (e.g., lampposts, crosswalks and/or curb); the location and directions of traffic lanes (e.g., the location and direction of a parking lane, a turning lane, a bicycle lane, or other lanes within a particular roadway or other travel way and/or one or more boundary markings associated therewith); traffic control data (e.g., the location and instructions of signage, traffic lights, or other traffic control devices); and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the vehicle 102. The positioning system 118 can be any device or circuitry for analyzing the position of the vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the vehicle 102 can be used by various systems of the vehicle computing system 112 and/or provided to one or more remote computing devices (e.g., the operations computing system 104 and/or the remote computing device 106). For example, the map data 122 can provide the vehicle 102 relative positions of the surrounding environment of the vehicle 102. The vehicle 102 can identify its position within the surrounding environment (e.g., across six axes) based at least in part on the data described herein. For example, the vehicle 102 can process the autonomy system sensor data 116 (e.g., LIDAR data, camera data) to match it to a map of the surrounding environment to get an understanding of the vehicle's position within that environment (e.g., transpose the vehicle's position within its surrounding environment).

The autonomy computing system 120 can include a perception system 124, a prediction system 126, a motion planning system 128, and/or other systems that cooperate to perceive the surrounding environment of the vehicle 102 and determine a motion plan for controlling the motion of the vehicle 102 accordingly. For example, the autonomy computing system 120 can receive the autonomy system sensor data 116 from the one or more autonomy system sensors 114, attempt to determine the state of the surrounding environment by performing various processing techniques on the autonomy system sensor data 116 (and/or other data), and generate an appropriate motion plan through the surrounding environment. The autonomy computing system 120 can control the one or more vehicle control systems 138 to operate the vehicle 102 according to the motion plan.

The perception system 124 can identify one or more objects that are proximate to the vehicle 102 based on autonomy system sensor data 116 received from the autonomy system sensors 114. In particular, in some implementations, the perception system 124 can determine, for each object, state data 130 that describes a current state of such object. As examples, the state data 130 for each object can describe an estimate of the object's: current location (also referred to as position); current speed; current heading (which may also be referred to together as velocity); current acceleration; current orientation; size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate to the vehicle 102 over time, and thereby produce a presentation of the world around a vehicle 102 along with its state (e.g., a presentation of the objects of interest within a scene at the current time along with the states of the objects).

The prediction system 126 can receive the state data 130 from the perception system 124 and predict one or more future locations and/or moving paths for each object based on such state data. For example, the prediction system 126 can generate prediction data 132 associated with each of the respective one or more objects proximate to the vehicle 102. The prediction data 132 can be indicative of one or more predicted future locations of each respective object. The prediction data 132 can be indicative of a predicted path (e.g., predicted trajectory) of at least one object within the surrounding environment of the vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128. In some implementations, one or more functions of the perception and/or prediction system can be combined and/or performed by the same system.

The motion planning system 128 can determine a motion plan and generate motion plan data 134 for the vehicle 102 based at least in part on the prediction data 132 (and/or other data). The motion plan data 134 can include vehicle actions with respect to the objects proximate to the vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the vehicle 102 can perform a certain action (e.g., pass an object) without increasing the potential risk to the vehicle 102 and/or violating any traffic laws (e.g., speed limits, lane boundaries, signage). The motion plan data 134 can include a planned trajectory, velocity, acceleration, and/or other actions of the vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost of adhering to a particular candidate motion plan over time. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle controller that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the vehicle 102. For instance, the vehicle 102 can include a mobility controller configured to translate the motion plan data 134 into instructions. By way of example, the mobility controller can translate a determined motion plan data 134 into instructions for controlling the vehicle 102 including adjusting the steering of the vehicle 102 “X” degrees and/or applying a certain magnitude of braking force. The mobility controller can send one or more control signals to the responsible vehicle control component (e.g., braking control system, steering control system and/or acceleration control system) to execute the instructions and implement the motion plan data 134.

The vehicle computing system 112 can include a communications system 136 configured to allow the vehicle computing system 112 (and the associated one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include the one or more human-machine interfaces 140. For example, the vehicle computing system 112 can include one or more display devices located on the vehicle computing system 112. A display device (e.g., screen of a tablet, laptop, and/or smartphone) can be viewable by a user of the vehicle 102 that is located in the front of the vehicle 102 (e.g., driver's seat, front passenger seat). Additionally, or alternatively, a display device can be viewable by a user of the vehicle 102 that is located in the rear of the vehicle 102 (e.g., a passenger seat in the back of the vehicle).

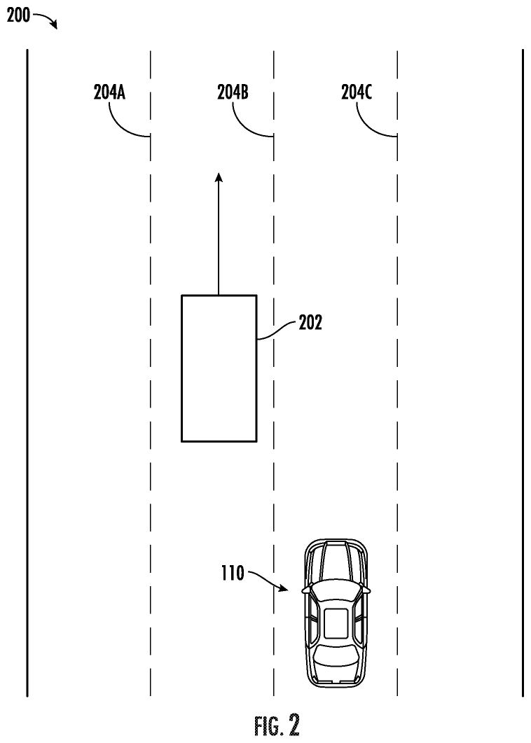

FIG. 2 depicts an example autonomous vehicle in a multi-lane road environment in accordance with the present disclosure. For example, a vehicle 110 (e.g., an autonomous vehicle or another vehicle type that includes sensor equipment) can travel through a portion of a travel way 200 (e.g., a road or other thoroughfare) and capture sensor data of the environment around the vehicle. In some examples, the vehicle can employ one or more of: a camera, a LIDAR system, or RADAR system to capture data of the environment surrounding the vehicle. A vehicle can travel through the portion of the travel way that is of interest at least once to capture sensor data for the environment surrounding the vehicle 110.

The surrounding environment of the vehicle can include, for example, a highway environment, an urban environment, a residential environment, a rural environment, and/or other types of environments. The surrounding environment can include one or more objects (e.g., another vehicle 202, an obstacle such as a building, and so on). The surrounding environment can include one or more lane boundaries (204A, 204B, and 204C). A lane boundary can include, for example, lane markings and/or other indicia associated with a travel lane and/or travel way (e.g., the boundaries thereof).

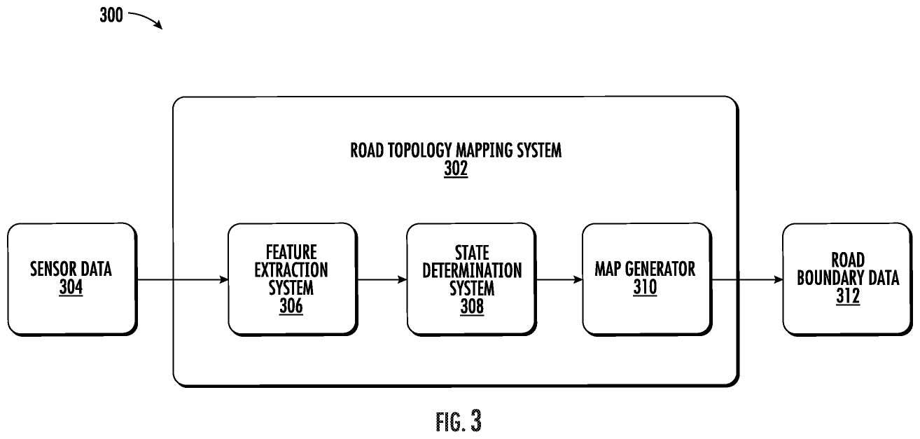

FIG. 3 depicts an example system 300 overview according to example embodiments of the present disclosure. Once a vehicle has traveled through a particular portion of a travel way, the captured sensor data 304 can be used as input to a road topology mapping system 302. In some examples, the sensor data 304 can include LIDAR data associated with the surrounding environment of the vehicle. The LIDAR data can be captured via a roof-mounted LIDAR system of the vehicle. The LIDAR data can be indicative of a LIDAR point cloud associated with the surrounding environment of the vehicle (e.g., created by LIDAR sweep(s) of the vehicle's LIDAR system). A computing system can project the LIDAR point cloud into a two-dimensional overhead view image (e.g., a bird's eye view image with a resolution of 960×960 at a 5 cm per pixel resolution). The rasterized overhead view image can depict at least a portion of the surrounding environment of the vehicle (e.g., a 48 m by 48 m area with the vehicle at the center bottom of the image). The LIDAR data can provide a sparse representation of at least a portion of the surrounding environment. In some implementations, the sensor data can be indicative of one or more sensor modalities (e.g., encoded in one or more channels). This can include, for example, intensity (e.g., LIDAR intensity) and/or other sensor modalities. In some implementations, the sensor data 304 can also include other types of sensor data (e.g., motion sensor data, camera sensor data, RADAR sensor data, SONAR sensor data, and so on).

The sensor data 304 can be used as input to the road topology mapping system 302. The road topology mapping system 302 can include one or more components that enable the road topology mapping system 302 to generate high-definition map data based on the sensor data 304, the components including a feature extraction system 306, a state determination system 308, and a map generator 310.

The feature extraction system 306 can include a machine-learned model. The machine-learned model can, using a LIDAR point cloud and camera data as input, identify one or more features in the environment including, but not limited to, lane boundaries (e.g., lines painted on the surface of the road way including solid lines and dashed lines), topography of the travel way (e.g., changes in elevation and turns), and obstacles (e.g., permanent features of the landscape and buildings). The feature extraction system 306 can then output a set of features for the portion of the travel way in which the sensor data was captured.

A state determination system 308 can access the set of features produced by the feature extraction system 306. Based on that list of features, the state determination system 308 can identify an initial vertex point for the area covered by the sensor data. For example, the state determination system 308 can determine a first edge of the area represented by the sensor data and identify a position at which at least one lane boundary intersects the edge of the data. Once the initial node position is determined, the state determination system 308 can determine one or more other characteristics of the node.

Using a machine-learned model and the feature data set, the state determination system 308 can determine a direction associated with the initial node (e.g., the direction in which the associated lane boundary is likely to continue in) and a state associated with the node. A state value can be one of: a fork state, a termination state, and a normal state (which can also be referred to as an unchanged state). A fork state can be determined when the current lane boundary is diverging into two lane boundaries. For example, an exit on a highway includes a new lane being introduced to allow vehicles to exit the highway. The lane boundary of a lane at the edge of the highway will diverge from the existing path to allow vehicles to exit. When a fork state is determined, the road topology mapping system 302 (using the map generator) can create a new lane boundary in a graph that represents the current travel way.

A termination state can represent that the current lane boundary is ending. This can occur when two lanes merge together and one of them no longer continues separately. Thus, when the most recent node for a specific lane boundary is determined to be in a termination state, the road topology mapping system 302 can cease generating new nodes for that lane boundary. An unchanging state can represent that the lane boundary continues on to the next node without forking or termination. In some examples, the state determination system 308 can determine a state for a node based on features in the feature set. Such features may include representations of the location and direction of lane boundaries lines. For example, an intersection of the current lane boundary with another lane boundary may indicate that the lane boundary is in a termination state and an unexpected change of direction for a given lane boundary which is not found in other lane boundaries may indicate a fork in the lane boundary is beginning.

A map generator 310 can, using the position, direction, and state information generated by the state determination system 308, generate a directed graph of nodes that represent the position and path of one or more lane boundaries. The map generator 310 can represent each lane boundary as a series of nodes, each node having an associated location, direction, and state. The directed graph can be generated iteratively, such that for each new node, the map generator 310 or state determination system 308 can identify an area of interest based on the determined state and direction for the new node. Using this identified area of interest and the feature set output by the feature extraction system 306, the map generator 310 can identify the next node in the directed graph. This process can continue until the road topology mapping system 302 reaches the end of the current sensor data set.

It should be noted that while a directed acyclic graph the representation that is primarily herein, other representations of lane boundaries can be produced by a machine-learned model. For example, the lane boundaries can be represented as a plurality of structured directed acyclic graphs that correspond to each lane boundary.

The road topology mapping system 302 can output road boundary data 312. The road boundary data 312 can include a representation of a plurality of lane boundaries in an acyclic directed graph. This boundary data can be used, with other map data, to provide a high-definition map for use by autonomous vehicles while navigating the section of a travel way represented by the road boundary data.

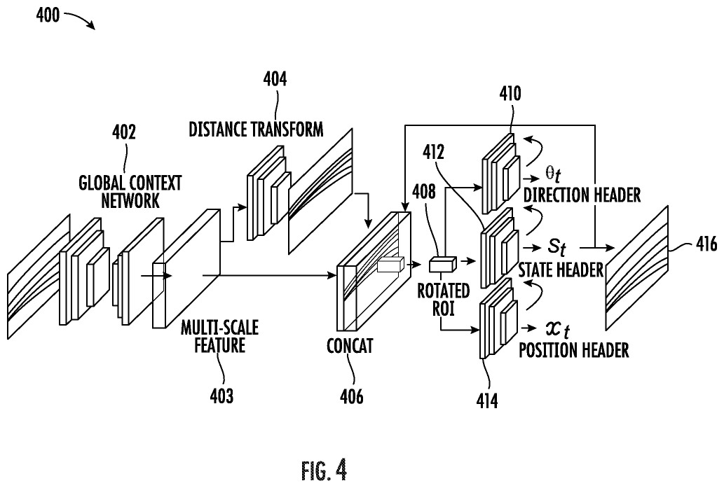

FIG. 4 depicts an example system overview according to example embodiments of the present disclosure. More specifically, the road topology mapping system 400 can include a plurality of components, each component associated with performing a particular part of the process of generating high-definition maps. The sensor data can include data representing a top-down view of a portion of a travel way (e.g., a road) based on point cloud data collected by a LIDAR system mounted on top of a vehicle and camera data.

A machine-learned model can accept the sensor data as input. For example, the machine-learned model can be a convolutional neural network (or other feed-forwards neural network). In other examples, the machine-learned model can be a recurrent neural network (or other neural network that uses its output for a particular input to analyze future inputs). Additionally, or alternatively, the road topology mapping system 400 can use multiple different models to leverage the strengths of convolutional neural networks and the strengths of recurrent neural networks.

Because the changes of topology can be very gradual a given area in the mapped data, it can be difficult for the machine-learned model to correctly identify state changes based on data collected for a relatively limited field of view around a vehicle. To enable better prediction of a current state, the road topology mapping system 400 can employ a global feature network 402 to generate context for each specific node in the lane boundary map. The road topology mapping system 400 can generate one or more bird's eye view images (e.g., images of dimension 8000 pixels in width by 1200 in height corresponding to 400 m by 60 m in the direction of travel of the mapping vehicle). A global feature network 402 can use an encoder-decoder architecture built upon a feature pyramid network that encodes the context of the lane boundaries and the scene. This represents a bottom-up, top-down structure that can enable the global feature network 402 to process and aggregate multi-scale features 403 and skip links that help preserve spatial information at each resolution. These multi-scale features can enable later components of the road topology mapping system 400 to contextualize each node such that the state of a given node can more accurately be determined.

The road topology mapping system 400 can also use a distance transform network 404 to generate distance transform representation of the sensor data. A distance transform representation of a portion of a travel way can encode, at each point in the image, the relative distance to the closest lane boundary. A distance transform representation of a particular portion of a travel way can be used as an additional input to other portions of the road topology mapping system 400. In addition, the distance transform representation can be analyzed (e.g., binarizing and skeletonizing) to identify a location to serve as the initial node (or vertex) of the graph for one or more lane boundaries.

It should be noted that, although the present system generally relies on a multi-scale feature representation and a distance transform representation of the particular portion of the travel way, other representations can be generated based on the sensor data. For example, the sensor data can be analyzed (e.g., by a trained neural network) to generate a truncated inverse distance transform of the location of the travel way boundaries (e.g., a lane boundary detection map), an endpoint map, and a vector field of normalized normal values to the road boundaries (e.g., a direction map which can be represented as a flow field).

Once a multi-scale feature data set and a distance transform representation have been generated, the road topology mapping system 400 can concatenate, using a concatenation system 406, them to produce a combined representation of the portion of the travel way included in the sensor data.

In some examples, the road topology mapping system 400 can use the combined representation as input to one or more further machine-learned models (e.g., neural networks). For example, the road topology mapping system 400 can identify an initial node (or vertex) based on the distance transform representation. For each node, the road topology mapping system 400 can generate a header. In some examples, the header can include one or more sub-headers, each sub-header including information about the node. For example, a header for a current node can include a direction header 410, a state header 412, and a position header 414. The position header 414 can describe the position of the current node. This position can be an absolute position (e.g., using GPS coordinates) or a relative position within a given area or image. The direction header 410 can include data describing an estimated direction for the lane boundary that the current node is part of. Thus, the direction header 410 can be used to determine where the next node may be. The state header 412 can include information about the state of the current node. As noted above, potential states can include a normal state, a fork state, and a termination state.

Using a machine-trained model, the row topology mapping system 400 can determine an estimated direction for the current node (e.g., the initial node or some subsequent node). In some examples, the estimated direction is based on one or more topological features, one or more features describing the position and direction of the lane boundaries, and the estimated direction for the parent node of the current node. In the example of the initial node, no direction information will be available for the parent node. The estimated direction can be stored in the direction header 410.

The road topology mapping system 400 can generate a region of interest for the next node in the directed graph based on the estimated direction associated with the current node. Thus, the road topology mapping system 400 can identify the location of the next node for the current lane boundary within the area of interest based on one or more lane boundary features and the distance transform representation. For example, if the estimated direction is directly eastward, the road topology mapping system 400 can generate an area of interest that is directly eastward of the current node. The size (e.g., the length and width) of the area of interest can be determined based on the number of nodes needed for the high definition mapping data.

The road topology mapping system 400 can use the generated region of interest, along with the feature data, as input to a machine-trained model to determine a state for the current node. This model considers the feature data for the current region of interest (and any other relevant features) to determine whether the current lane boundary is diverging from a given path (e.g., forking to create a new lane boundary) or is intersecting with another lane boundary (e.g., merging). The model can generate a confidence value for each of the three possible states and select the state with the highest generated confidence value.

The road topology mapping system 400 can use another machine-learned model (or a portion of an existing machine-learned model) to identify the next node for the current lane boundary within the area of interest. For example, a convolutional neural network can predict a probability distribution over all possible positions within the region of interest along the lane boundary generated by the direction header. The region of interest can be bilinearly interpolated from the combined representation and an encoding of the state of the current node. After the interpolation, the road topology mapping system 400 can up-sample the region of interest to the original image dimension and passes it to a convolutional recurrent neural network (RNN). The output of the RNN can be fed to a lightweight encoder-decoder network that outputs a soft-max probability map of the position of the next node that is mapped to the global coordinate frame of the image.

For example, the road topology mapping system 400 can identify a particular point along a lane boundary (which is identified based on the feature data) and establish that point as the location of the next node (or vertex) in the directed graph. Each new node can be added to the directed graph (along with any pertinent header information). Depending on the state, a graph describing a current lane boundary can end (if the current node is determined to be in a termination state). Conversely, if the current node is determined to be in a fork state, the road topology mapping system 400 can generate a new lane boundary to be represented within the graph.

Once the road mapping topology system 400 identifies the location of the next node in the graph for a given road boundary, the process of determining, using machine-learned models, the estimated direction and estimated state for that node is repeated. The entire process can be repeated to identify additional nodes until the end of the data is reached (e.g., the end of the area of travel way represented by the sensor data.)

Thus, given input sensor data D, the output of the system will be a most likely directed graph (G) from the plurality of all possible directed graphs. The graph will include a series of nodes (v), each node encoding geometric and topological properties of a local region of a lane boundary. For example, each node can be defined as vi=(xᵢ, θᵢ, sᵢ), wherein xi represents the position of a vertex represented by the node, θᵢ represents the turning angle of the previous vertex position, and sᵢ, is a variable that represents the state of the lane boundary at this node. The process of generating a graph (G) of a plurality of nodes (v) can be represented as:

$${V}^{*} = arg {max}_{v ∈ G} p ( V \vert D )$$

Thus, the characteristics of each node can be calculated based on Bayes-ball algorithm, the joint probability distribution p(V|D) of each graph can be factorized into:

$$p ( v ) = {\prod }_{{v}_{i} ∈ V} p ( {v}_{i} \vert {v}_{i p ( i )} , D )$$

Each conditional probability can further be decomposed into the specific geometric and topological components as follows:

p(vᵢ|vᵢₚ₍ᵢ₎,D)=p(θᵢ|θₚ₍ᵢ₎,sₚ₍ᵢ₎,xₚ₍ᵢ₎,D)×p(xᵢ|θᵢ,sₚ₍ᵢ₎,xₚ₍ᵢ₎,D)×p(sᵢ|θᵢ,sₚ₍ᵢ₎,xₚ₍ᵢ₎,D)

An example algorithm for generating a directed acyclic graph is shown below. This general pseudo code represents a particular implementation of the method described herein.

```
Input: Sensor data (Aggregated point clouds) and initial vertices {vᵢₙᵢₜ = (θᵢₙᵢₜ, xᵢₙᵢₜ,
sᵢₙᵢₜ)}
Output: Directed Acyclic Graph of Highway Topology
Initialize queue Q with vertices {vᵢₙᵢₜ};
while Q not empty do
  vᵢ ← Q.pop( );
  while _{Sp(i)} not Terminate do
    θᵢ ← argmax p(θᵢ | θₚ₍ᵢ₎, _{SP(i)}, _{XP(i)});
    xᵢ ← argmax p(xᵢ | θ_{i, SP(i)}, _{XP(i)});
    sᵢ ← argmax p(sᵢ | θᵢ, _{SP(i)}, _{XP(i)});
    if sᵢ = Fork then
      Q.insert(vᵢ);
    end
    i ← C(i);
  end
end
```

As seen above, the method describes a system that takes input in the form of sensor data (e.g., aggregated point clouds) and initial vertices. Each initial vertex represents a specific lane boundary. The initial vertices can be stored as a list of points in a queue (Q), each with a location (xᵢₙᵢₜ), a direction (θᵢₙᵢₜ), and a state (sᵢₙᵢₜ). The system can then access the first initial vertex (vᵢₙᵢₜ) from the queue. The method then, as long as the state of the current node (in this case the initial node), is not “terminate” the system will calculate a most likely direction (θi) for the new current node based on the direction of the previous node θₚ₍ᵢ₎, the state of the previous node (sP(i)), and the location of the previous node (x_{P(i)}).

The system can then calculate a most likely position (xi) for the current node based on the estimated direction (θi) of the previous node calculated in the last step, the state of the previous node (s_{P(i)}), and the location of the previous node (x_{P(i)}). The system can calculate a most likely state (sᵢ) for the current node based on the estimated direction (θi) of the current node calculated in the last step, the state of the previous node (s_{P(i)}), and the location of the previous node (xₚ₍ᵢ₎). If the state of the current node is a fork state, the system inserts a new initial vertex for a new lane boundary into the queue (Q).

The system can identify a child node of the current node and assign it as the new current node and then repeat the above process until all the lane boundaries have been mapped to completion.

The road topology mapping system can output an acyclic directed graph 416 representing a plurality of lane boundaries (wherein the lane boundaries define the lanes of a highway or road.) The graph is acyclic because there are no paths within the graph that can return to a node once it has been traversed. The graph is directed because the paths from one node to another only run in a single direction. The graph can be composed of a plurality of nodes or vertices connected by a plurality of edges. In some examples, the nodes can have states that represent the beginning of a lane boundary (e.g., a fork state) or the end of a lane boundary (e.g., a termination state). These acyclic directed graphs can be used to generate high-definition maps for use by autonomous vehicles.

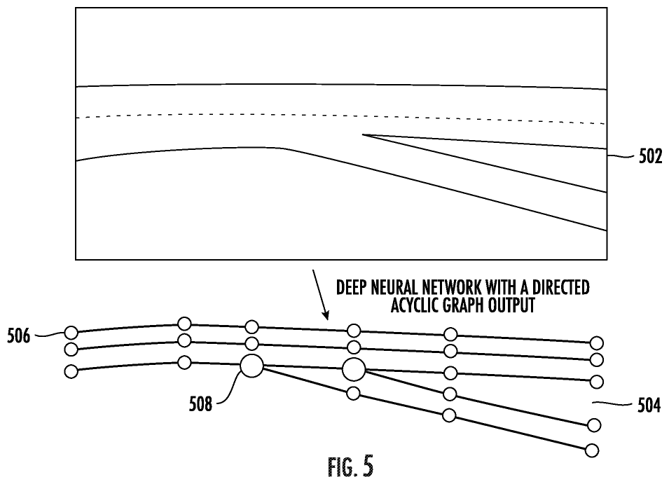

FIG. 5 depicts an of a directed acyclic graph according to example embodiments of the present disclosure. In some examples, the road topology mapping system (e.g., road topology mapping system 302 in FIG. 3) generates a graph 504 for a travel way with multiple different lane boundaries. For example, the road topology mapping system can access sensor data representing a section of a travel way. In this example, the section of roadway 502 is represented from a top-down view. The road topology mapping system can identify a plurality of initial vertices or nodes, one for each lane boundary from the sensor data.

The initial vertex can represent the position at which each lane boundary intersects an edge of the sensor data (e.g., the edge of an image or a point cloud such as the point labeled 506). For each initial vertex or node, the road topology mapping system can process the sensor data to determine a series of nodes for that lane boundary. The road topology mapping system can continue to generate nodes for that lane boundary until the lane boundary is determined to reach a termination point for that lane boundary. The termination point for a particular lane boundary can be the point at which it merges with another lane boundary or the point at which it reaches another edge of the sensor data.

In some examples, the road topology mapping system can determine that a particular node has a state the indicates either the beginning or ending of a particular lane boundary. In this example, node 508 has been determined to represent a “fork” state and thus represents the beginning of the new lane boundary.

Once all the nodes for a particular lane boundary are determined, the road topology mapping system can continue that process with another initial node for the next lane boundary. This process can be repeated until all lane boundaries have been mapped to completion.

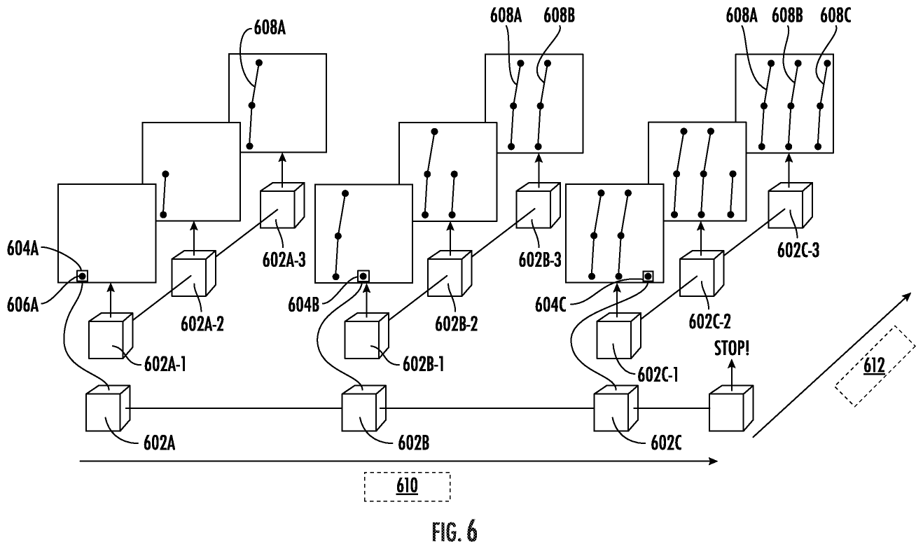

FIG. 6 depicts a diagram illustrating an example process for iterative lane graph generation according to example embodiments of the present disclosure. This illustrates, for example, the overall structure of the process by which a first machine-learned model(s) 610 (e.g., a convolutional recurrent neural network or recurrent neural network) can sequentially identify the initial nodes of the lane boundaries while a second machine-learned model(s) (e.g., a convolutional recurrent neural network) can generate acyclic graphs indicative of the lane boundaries. Each stage shown in FIG. 6 can represent a time (e.g., time step, time frame, point in time, etc.), a stage of the process, etc. for iteratively generating the directed graphs. For example, as described herein, the first machine-learned model(s) 610 (e.g., the machine-learned lane boundary detection model) can identify a plurality of lane boundaries (e.g., lane boundaries 204A-C in FIG. 2) at stages 602A-C. The first machine-learned model(s) 610 can generate an output that includes data indicative of one or more regions 604A-C associated with one or more lane boundaries 204A-C. For example, the data indicative of the one or more regions associated with one or more lane boundaries can include a first region 604A associated with a first lane boundary 204A, a second region 604B associated with a second lane boundary 204B, and/or a third region 604C associated with a third lane boundary 204C. Each region 604A-C can be an initial region associated with a respective lane boundary 204A-C. For example, the first region 604A can include a starting vertex 606A for the directed acyclic graph 608A (e.g., representation of the first lane boundary 204A).

The second machine-learned model(s) 612 (e.g., a convolutional recurrent neural network or recurrent neural network) can utilize the first region 604A to identify the starting vertex 606A and to begin to generate the directed acyclic graph 608A. The second machine-learned model(s) 612 can iteratively draw a first directed acyclic graph 608A as a sequence of vertices. A section (e.g., of dimension Hc×Wc) around this region can be cropped from the output feature map of the decoder 506 of and fed into the second machine-learned model(s) 612 (e.g., at time 604A-1). The second machine-learned model(s) 612 can then determine (e.g., using a logistic function, softmax, etc.) a position of the next vertex (e.g., at the time 604A-2) based at least in part on the position of the first starting vertex 606A. The second machine-learned model(s) 612 can use the position of this vertex to determine the position of the next vertex (e.g., at the time 604A-3). This process can continue until the lane boundary 204A is fully traced (or the boundary of the sensor data is reached) as the first directed acyclic graph 608A.

After completion of the first directed acyclic graph 608A, the second machine-learned model(s) 612 (e.g., the machine-learned lane boundary generation model) can perform a similar process to generate a second directed acyclic graph 608B associated with a second lane boundary 204B at times 602B-1, 602B-2, 602B-3, etc. based at least in part on the second region 604B as identified by the first machine-learned model(s) 610 (e.g., the machine-learned lane boundary detection model). After completion of the second directed acyclic graph 608B, the second machine-learned model(s) 612 (e.g., the machine-learned lane boundary generation model) can perform a similar process to generate a third directed acyclic graph 608C associated with a third lane boundary 204C at times 602C-1, 602C-2, 602C-3, etc. based at least in part on the third region 604C as identified by the first machine-learned model(s) 610 (e.g., the machine-learned lane boundary detection model). In some implementations, the second machine-learned model(s) 612 can be trained to generate one or more of the directed acyclic graphs 608A-C during concurrent time frames (e.g., at least partially overlapping time frames). The second machine-learned model(s) 612 (e.g., the convolutional long short-term memory recurrent neural network) can continue the process illustrated in FIG. 6 until the first machine-learned model(s) 610 (e.g., the convolutional recurrent neural network) signals a stop.

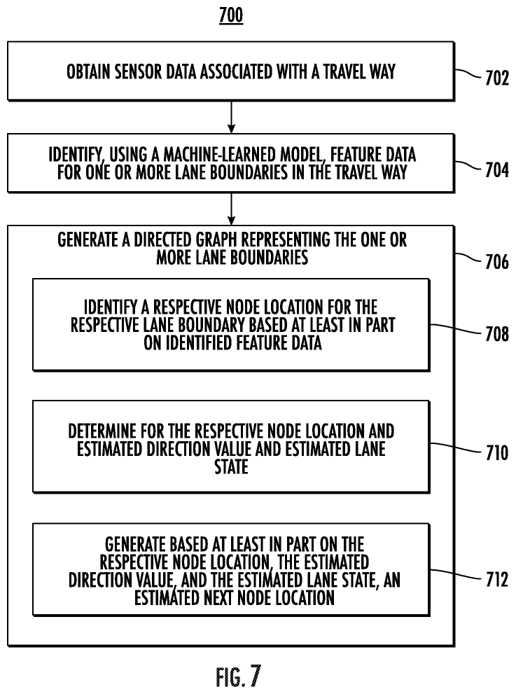

FIG. 7 depicts an example flow diagram 700 for generating a graph representation of a road according to example embodiments of the present disclosure. In some embodiments, a road topology mapping system (e.g., road topology mapping system 302 in FIG. 3) can obtain, at 702, sensor data associated with a portion of a travel way. In some embodiments, the sensor data includes data captured by sensors during a single trip of an autonomous vehicle through the portion of the travel way.

In some embodiments, a road topology mapping system can identify, at 704, feature data associated with one or more lane boundaries in the portion of the travel way based on the obtained sensor data. In some examples, the one or more lane boundaries can form a lane merge in which two lanes are combined into a single lane. In some examples, the one or more lane boundaries can form a lane fork in which a lane diverges from an existing lane (e.g., a highway exit). In some examples, the machine-learned model can be a convolutional neural network or a recurrent neural network.

In some embodiments, a road topology mapping system can generate, at 706, a graph representing the one or more lane boundaries associated with the portion of the travel way. In some examples, generating the graph for a respective lane boundary can comprise the road topology mapping system can identify, at 708, a respective node location for the respective lane boundary based at least in part on identified feature data associated with lane boundary information. In some examples, the respective node location can be located at a position along a lane boundary.

In some embodiments, the road topology mapping system can determine, at 710, for the respective node location, an estimated direction value and an estimated lane state. In some examples, the estimated lane state can be one of an unchanged state, a termination state, or a fork state. The road topology mapping system can determine that the estimated lane state is the termination state. In response to determining that the estimate lane state is the termination state, the road topology mapping system can cease to generate the graph for the respective lane boundary.

In some embodiments, the road topology mapping system can determine that the estimated lane state is the termination state. In response to determining that the estimate lane state is the termination state, the road topology mapping system can initiate a graph for a new lane boundary. In some examples, the estimated direction value is determined based on a location of one or more other nodes.

In some embodiments, the road topology mapping system can generate, at 712, based at least in part on the respective node location, the estimated direction value, and the estimated lane state, a predicted next node location. In some examples, the road topology mapping system can determine an area of interest based at least in part on the respective node location, the estimated direction value, and the estimated lane state. The road topology mapping system can determine the predicted next node location within the area of interest based, at least in part, on the feature data associated with the one or more lane boundaries.

In some embodiments, the road topology mapping system can generate further predicted node locations based on the feature data associated with the one or more lane boundaries in the portion until a determined area of interest is outside of the portion of the travel way. In some examples, the respective node location and the predicted next node location can be coordinates in a polyline.

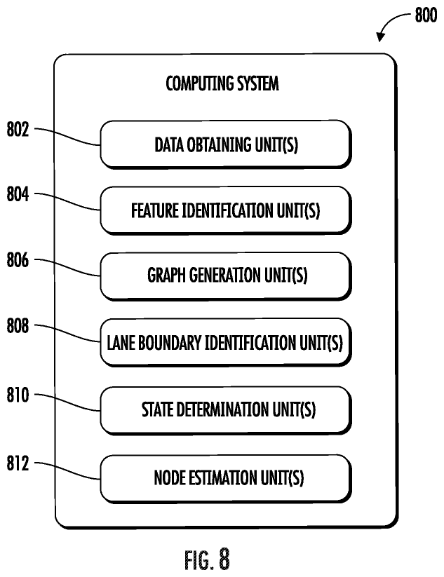

Various means can be configured to perform the methods and processes described herein. For example, FIG. 8 depicts a diagram of an example of an example computing system can include data obtaining unit(s) 802, feature identification unit(s) 804, graph generation unit(s) 806, lane boundary unit(s) 808, state determination unit(s) 810, node estimation unit(s) 812 and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means can be configured to obtain sensor data associated with a portion of a travel way. For example, a road topology mapping system can receive sensor data captured by one or more autonomous vehicles while traveling the portion of the travel way. A data obtaining unit 802 is one example of a means for obtaining sensor data associated with a portion of a travel way.

The means can be configured to identify, using a machine-learned model, feature data associated with one or more lane boundaries in the portion of the travel way based on the obtained sensor data. For example, the road topology mapping system can identify lane boundaries and topology changes within the portion of the travel way based on analyzing the obtained sensor data. A feature identification unit 804 is one example of a means for identifying, using a machine-learned model, feature data associated with one or more lane boundaries in the portion of the travel way based on the obtained sensor data.

The means can be configured to generate, using the machine-learned model, a graph representing the one or more lane boundaries associated with the portion of the travel way. For example, the road topology mapping system can create a directed graph that represents each lane boundary associated with the portion of the travel way. A graph generation unit 806 is one example of a means for generating, using the machine-learned model, a graph representing the one or more lane boundaries associated with the portion of the travel way.

To generate the graph for a respective lane boundary, the means can be configured to identify a respective node location for the respective lane boundary based at least in part on identified feature data associated with lane boundary information. For example, the road topology mapping system can use information about lane boundaries from the feature data to identify a node location. A lane boundary unit 808 is one example of a means for identifying a respective node location for the respective lane boundary based at least in part on identified feature data associated with lane boundary information.

The means can be configured to determine, for the respective node location, an estimated direction value and an estimated lane state. For example, the road topology mapping system can determine the state and direction of the respective node based on feature data and the state and direction of the previous node. A state determination unit 810 is one example of a means for determining, for the respective node location, an estimated direction value and an estimated lane state.

The means can be configured to generate, based at least in part on the respective node location, the estimated direction value, and the estimated lane state, a predicted next node location. For example, the road topology mapping system can make a prediction of the location of the next node based on the direction, state, and location of the previous node. A node estimation unit 812 is one example of a means for generating, based at least in part on the respective node location, the estimated direction value, and the estimated lane state, a predicted next node location.

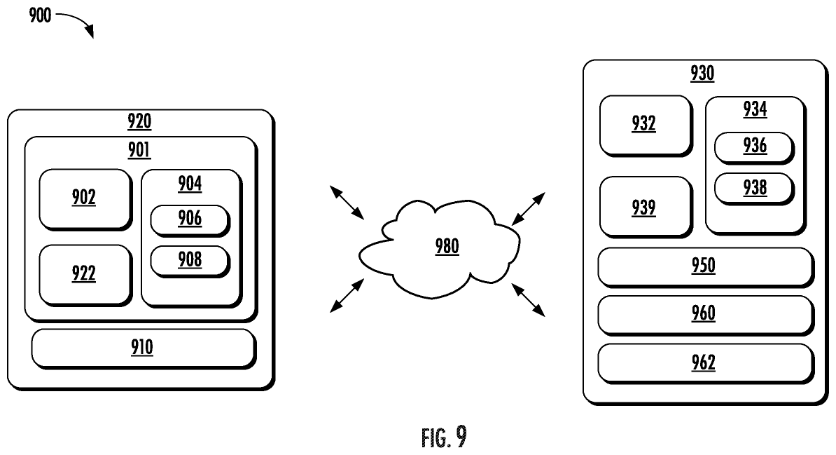

FIG. 9 depicts a block diagram of an example computing system 900 according to example embodiments of the present disclosure. The example system 900 includes a computing system 920 and a machine learning computing system 930 that are communicatively coupled over a network 980.

In some implementations, the computing system 920 can perform generating a representation of a road by discovering lane topology. In some implementations, the computing system 920 can be included in an autonomous vehicle. For example, the computing system 920 can be on-board the autonomous vehicle. In other implementations, the computing system 920 is not located on-board the autonomous vehicle. For example, the computing system 920 can operate offline to generate a representation of a road by discovering lane topology. The computing system 920 can include one or more distinct physical computing devices.

The computing system 920 includes one or more processors 902 and a memory 904. The one or more processors 902 can be any suitable processing device (e.g., a processor core, a microprocessor, an ASIC, a FPGA, a controller, a microcontroller, etc.) and can be one processor or a plurality of processors that are operatively connected. The memory 904 can include one or more non-transitory computer-readable storage media, such as RAM, ROM, EEPROM, EPROM, one or more memory devices, flash memory devices, etc., and combinations thereof.

The memory 904 can store information that can be accessed by the one or more processors 902. For instance, the memory 904 (e.g., one or more non-transitory computer-readable storage mediums, memory devices) can store data 906 that can be obtained, received, accessed, written, manipulated, created, and/or stored. The data 906 can include, for instance, services data (e.g., assignment data, route data, user data etc.), data associated with autonomous vehicles (e.g., vehicle data, maintenance data, ownership data, sensor data, map data, perception data, prediction data, motion planning data, etc.), graph data (e.g., feature data, initial node data, node direction data, node location data, node state data), and/or other data/information as described herein. In some implementations, the computing system 920 can obtain data from one or more memory device(s) that are remote from the system 920.

The memory 904 can also store computer-readable instructions 908 that can be executed by the one or more processors 902. The instructions 908 can be software written in any suitable programming language or can be implemented in hardware. Additionally, or alternatively, the instructions 908 can be executed in logically and/or virtually separate threads on processor(s) 902.

For example, the memory 904 can store instructions 908 that when executed by the one or more processors 902 cause the one or more processors 902 to perform any of the operations and/or functions described herein, including, for example, the functions for generating a representation of a road by discovering lane topology (e.g., one or more portions of method 700).

According to an aspect of the present disclosure, the computing system 920 can store or include one or more machine-learned models 910. As examples, the machine-learned models 910 can be or can otherwise include various machine-learned models such as, for example, neural networks including feed-forward neural networks, recurrent neural networks (e.g., long short-term memory recurrent neural networks), convolutional neural networks, or other forms of neural networks.

In some implementations, the computing system 920 can receive the one or more machine-learned models 910 from the machine learning computing system 930 over network 980 and can store the one or more machine-learned models 910 in the memory 904. The computing system 920 can then use or otherwise implement the one or more machine-learned models 910 (e.g., by processor(s) 902). In particular, the computing system 920 can implement the machine learned model(s) 910 to generate a representation of a road by discovering lane topology.

The machine learning computing system 930 includes one or more processors 932 and a memory 934. The one or more processors 932 can be any suitable processing device (e.g., a processor core, a microprocessor, an ASIC, a FPGA, a controller, a microcontroller, etc.) and can be one processor or a plurality of processors that are operatively connected. The memory 934 can include one or more non-transitory computer-readable storage media, such as RAM, ROM, EEPROM, EPROM, one or more memory devices, flash memory devices, etc., and combinations thereof.

The memory 934 can store information that can be accessed by the one or more processors 932. For instance, the memory 934 (e.g., one or more non-transitory computer-readable storage mediums, memory devices) can store data 936 that can be obtained, received, accessed, written, manipulated, created, and/or stored. The data 936 can include, for instance, sensor data (e.g., image data and LIDAR data), feature data (e.g., data extracted from the sensor data), graph data (e.g., initial node data, node direction data, node location data, node state data), and/or other data/information as described herein. In some implementations, the machine learning computing system 930 can obtain data from one or more memory device(s) that are remote from the system 930.

The memory 934 can also store computer-readable instructions 938 that can be executed by the one or more processors 932. The instructions 938 can be software written in any suitable programming language or can be implemented in hardware. Additionally, or alternatively, the instructions 938 can be executed in logically and/or virtually separate threads on processor(s) 932.

For example, the memory 934 can store instructions 938 that when executed by the one or more processors 932 cause the one or more processors 932 to perform any of the operations and/or functions described herein, including, for example, the functions for generating a representation of a road by discovering lane topology (e.g., one or more portions of method 700).

In some implementations, the machine learning computing system 930 includes one or more server computing devices. If the machine learning computing system 930 includes multiple server computing devices, such server computing devices can operate according to various computing architectures, including, for example, sequential computing architectures, parallel computing architectures, or some combination thereof.

In addition or alternatively to the model(s) 910 at the computing system 920, the machine learning computing system 930 can include one or more machine-learned models 940. As examples, the machine-learned models 940 can be or can otherwise include various machine-learned models such as, for example, neural networks including feed-forward neural networks, recurrent neural networks (e.g., long short-term memory recurrent neural networks), convolutional neural networks, or other forms of neural networks.

As an example, the machine learning computing system 930 can communicate with the computing system 920 according to a client-server relationship. For example, the machine learning computing system 930 can implement the machine-learned models 940 to provide a web service to the computing system 920. For example, the web service can provide remote assistance for generating a representation of a road by discovering lane topology.

Thus, machine-learned models 910 can located and used at the computing system 920 and/or machine-learned models 940 can be located and used at the machine learning computing system 930.

In some implementations, the machine learning computing system 930 and/or the computing system 920 can train the machine-learned models 910 and/or 940 through use of a model trainer 960. The model trainer 960 can train the machine-learned models 910 and/or 940 using one or more training or learning algorithms. One example training technique is a symmetric Chamfer distance to determine how closely a specific graph (or directed acyclic graph) Q matches a predicted graph (or directed acyclic graph) using the following formula:

$$L ( P , Q ) = {\sum }_{i} {min}_{q ∈ Q} {‖ {p}_{i} - q ‖}_{2} + {\sum }_{j} {min}_{p ∈ Q} {‖ p - {q}_{j} ‖}_{2}$$

Note that p and q are the densely sampled coordinates on directed acyclic graphs P and Q respectively.

In some implementations, the model trainer 960 can perform supervised training techniques using a set of labeled training data. In other implementations, the model trainer 160 can perform unsupervised training techniques using a set of unlabeled training data. The model trainer 960 can perform a number of generalization techniques to improve the generalization capability of the models being trained. Generalization techniques include weight decays, dropouts, or other techniques.

In particular, the model trainer 960 can train a machine-learned model 910 and/or 940 based on a set of training data 962. The training data 962 can include, for example, examples of past road topologies (e.g., including the sensor data that was collected to create those road topologies) and the resulting directed graphs. In some implementations, these data has been labeled prior to the training. The model trainer 960 can be implemented in hardware, firmware, and/or software controlling one or more processors.

The computing system 920 can also include a network interface 922 used to communicate with one or more systems or devices, including systems or devices that are remotely located from the computing system 920. The network interface 922 can include any circuits, components, software, etc. for communicating with one or more networks (e.g., 980). In some implementations, the network interface 922 can include, for example, one or more of: a communications controller, receiver, transceiver, transmitter, port, conductors, software and/or hardware for communicating data. Similarly, the machine learning computing system 930 can include a network interface 939.

The network(s) 980 can be any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 980 can be accomplished, for instance, via a network interface using any type of protocol, protection scheme, encoding, format, packaging, etc.

FIG. 9 illustrates one example computing system 900 that can be used to implement the present disclosure. Other computing systems can be used as well. For example, in some implementations, the computing system 920 can include the model trainer 960 and the training dataset 962. In such implementations, the machine-learned models 910 can be both trained and used locally at the computing system 920. As another example, in some implementations, the computing system 920 is not connected to other computing systems.

In addition, components illustrated and/or discussed as being included in one of the computing systems 920 or 930 can instead be included in another of the computing systems 920 or 930. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and/or equivalents to such embodiments. Accordingly, the subject disclosure does not preclude inclusion of such modifications, variations, and/or additions to the present subject matter as would be readily apparent to one of ordinary skill in the art. For instance, features illustrated and/or described as part of one embodiment can be used with another embodiment to yield a still further embodiment. Thus, it is intended that the present disclosure cover such alterations, variations, and/or equivalents.

What is claimed is:

1. A computer-implemented method comprising:
obtaining, by a computing system comprising one or more computing devices, sensor data associated with a portion of a travel way;
identifying, by the computing system and using a machine-learned model, feature data associated with one or more lane boundaries in the portion of the travel way based on the obtained sensor data; and
generating, by the computing system and the machine-learned model, a graph representing the one or more lane boundaries associated with the portion of the travel way, wherein generating the graph for a respective lane boundary comprises:
identifying, by the computing system, a respective node location for the respective lane boundary based at least in part on identified feature data associated with lane boundary information;
determining, by the computing system, for the respective node location, an estimated direction value and an estimated lane state; and
generating, by the computing system and based at least in part on the respective node location, the estimated direction value, and the estimated lane state, a predicted next node location.

2. The computer-implemented method of claim 1, wherein the generated graph is a directed acyclic graph.

3. The computer-implemented method of claim 1, wherein the respective node location is located at a position along a lane boundary.

4. The computer-implemented method of claim 1, wherein the estimated lane state is one of an unchanged state, a termination state, or a fork state.

5. The computer-implemented method of claim 4, the method further comprising:
determining, by the computing system, that the estimated lane state is the termination state; and
in response to determining that the estimate lane state is the termination state, ceasing, by the computing system, to generate the graph for the respective lane boundary.

6. The computer-implemented method of claim 4, further comprising:
determining, by the computing system, that the estimated lane state is the termination state; and
in response to determining that the estimate lane state is the termination state, initiating, by the computing system, a graph for a new lane boundary.

7. The computer-implemented method of claim 1, wherein generating, based at least in part on the respective node location, the estimated direction value, and the estimated lane state, the predicted next node location further comprises:
determining, by the computing system, an area of interest based at least in part on the respective node location, the estimated direction value, and the estimated lane state, and
determining the predicted next node location within the area of interest based, at least in part, on the feature data associated with the one or more lane boundaries.

8. The computer-implemented method of claim 1, wherein generating the graph representing the one or more lane boundaries associated with the portion of the travel way further comprises:
generating further predicted node locations based on the feature data associated with the one or more lane boundaries in the portion until a determined area of interest is outside of the portion of the travel way.

9. The computer-implemented method of claim 1, wherein the estimated direction value is determined based on a location of one or more other nodes.

10. The computer-implemented method of claim 1, wherein the one or more lane boundaries form a lane merge.

11. The computer-implemented method of claim 1, wherein the one or more lane boundaries form a lane fork.

12. The computer-implemented method of claim 1, wherein the sensor data includes data captured during a single trip of an autonomous vehicle through the portion of the travel way.

13. The computer-implemented method of claim 1, wherein the machine-learned model one of a convolutional neural network or a recurrent neural network.

14. The computer-implemented method of claim 1, wherein the respective node location and the predicted next node location are coordinates in a polyline.

15. A computing system comprising:
one or more processors; and
one or more tangible, non-transitory, computer readable media that collectively store instructions that when executed by the one or more processors cause the computing system to perform operations comprising:
obtaining sensor data associated with a portion of a travel way;
identifying, using a machine-learned model, feature data associated with one or more lane boundaries in the portion of the travel way based on the obtained sensor data; and
generating, using the machine-learned model, a graph representing the one or more lane boundaries associated with the portion of the travel way, wherein generating the graph for a respective lane boundary comprises:
identifying a respective node location for the respective lane boundary based at least in part on the feature data associated with lane boundary information;
determining for the respective node location, an estimated direction value and an estimated lane state; and
generating, based at least in part on the respective node location, the estimated direction value, and the estimated lane state, a predicted next node location.

16. The computing system of claim 15, wherein the generated graph is a directed acyclic graph.

17. The computing system of claim 15, wherein the estimated lane state is one of an unchanged state, a termination state, or a fork state.

18. A computing system, comprising:
one or more tangible, non-transitory computer-readable media that store:
a first portion of a machine-learned model that is configured to identify feature data based at least in part on at least in part on input data associated with sensor data and to generate an output that includes a plurality of features associated with one or more lane boundaries along a particular section of a travel way;
a second portion of the machine-learned model that is configured to estimate a current state and direction of a lane based at least in part on past states and directions of the lane and feature data associated with the lane; and
a third portion of the machine-learned model that is configured to generate a predicted next node location for a particular lane based at least in part on a current node location and an estimated state and estimated direction of the lane.

19. The computing system of claim 18, wherein an estimated lane state is one of an unchanged state, a termination state, or a fork state.

20. The computing system of claim 18, wherein the first portion of the machine-learned model comprises a global feature network configured to generate a plurality of features based, at least in part, on the input data and a distance transform network configured to identify initial vertices of the one or more lane boundaries;
the second portion of the machine-learned model comprises a state header configured to determine a state of a current node and a direction header configured to determine a direction of the current node; and
the third portion comprises a location header configured to predict a location of a next node.
